(19) United States
(12) Patent Application Publication
(10) Pub. No.: US 2006/0244917 A1
(43) Pub. Date: Nov. 2, 2006

(54) Method for exhibiting motion picture films at a higher frame rate than that in which they were originally produced

(76) Inventor: Robert C. Weisgerber, New York, NY (US)

Correspondence Address: DAVID PETER ALAN, ESQ., 81 Second St., South Orange, NJ, 07079, US

(21) Appl. No.: 11/478,940

(22) Filed: Jun. 30, 2006

Related U.S. Application Data
(63) Continuation-in-part of application No. 10/846,611, filed on May 17, 2004, now abandoned.

(51) Int. Cl. G03B 41/00

(52) U.S. Cl. 352/84

(57) ABSTRACT

Previously-produced motion picture films are enhanced for theatrical exhibition, at double the frame rate at which they were originally produced. Synthesized images are interpolated between each of the images of the original film. These interpolated images are generated through the use of computer software that analyzes the actual horizontal and vertical displacement of each pixel of every image of the original motion picture, so the interpolated images accurately depict the exact image that would have been captured, if the original motion picture had been produced at double the actual frame rate of production. This enhancement technique can also be used selectively for certain scenes or sequences of a motion picture, and not for other scenes or sequences of the same motion picture. The invention uses the 70 mm film format, and picture information can be added to films originally produced in the 35 mm format, if necessary.

This application is a continuation-in part of application Ser. No. 10/846,611, filed May 17, 2004.

### FIELD OF THE INVENTION

This invention relates to the enhancement of previously-produced motion pictures for exhibition to audiences in motion picture theaters, with upgraded quality of presentation, compared to that obtainable from the motion pictures as originally produced.

### BACKGROUND OF THE INVENTION

Most motion picture films produced for conventional theatrical exhibition are photographed at the speed of twenty-four frames per second, a frame rate that has been in use for most of the history of cinema. At that frame rate, there persist undesirable artifacts that detract from the appearance of reality that is a goal of modern motion picture production. Films shot at that rate have flicker, perceptible grain, and an appearance of motion that does not seem smooth. This latter artifact is particularly objectionable on large theater screens (fifty feet or more in width), since any image component must move a greater physical distance between discrete images on a large screen than on a smaller screen.

Films shot at higher frame rates succeeded, to some extent, in suppressing this undesirable artifact. Cinerama (three synchronized filmstrips photographed and projected at twenty-six frames per second, primarily used for travelogues) was somewhat successful in reducing flicker. The original Todd-AO system utilized actual photography at thirty frames per second, in addition to the conventional twenty-four frames per second. A few motion pictures, including Oklahoma and Around the World in Eighty Days, were produced in that format. However, the use of separate photography at two different frame rates was costly, and few films were produced in the Todd-AO format. More recently, the inventor herein taught a means for transitioning between film sequences photographed for exhibition at 24 frames per second and other sequences photographed at 30 frames per second between scenes of a single motion picture (U.S. Pat. No. 5,096,286 (1992)). While there was a perceptible improvement in smoothness of motion at the higher frame rate, the latter system was never developed commercially.

More recently, Weisgerber has taught the use of forty-eight frames per second as a rate for photographing and showing motion pictures, to develop a presentation that suppresses the undesirable artifacts present at twenty-four frames per second (U.S. Pat. No. 5,627,614 (1997)). In that invention, certain sequences or certain image components were photographed at forty-eight frames per second, for a “high-impact” presentation. Other sequences or image components were photographed at twenty-four frames per second and double-frame printed, to retain the artifacts that gave the film the “legacy” look. With the entire motion picture produced according to that invention projected at forty-eight frames per second, it became possible to give certain portions of a motion picture film or certain image components a more realistic look than other portions of the film or other image components. In order to deliver the full impact to the audience, the preferred embodiment of that invention used a large format, such as 70 mm theatrical format, equivalent to eight perforations high, with images anamorphically squeezed onto the conventional 70 mm (five-perforation) format for storage on the film reel and stretched to the eight-perforation aspect ratio upon projection in the theater.

The previously-mentioned invention only works optimally in films produced according to it. This means that it only delivers the full audience effect in new films. For films already in existence, the full effect can only be delivered if those films are enhanced and converted for projection at a frame rate of forty-eight frames per second or higher. Most commercially produced films, including IMAX films, are photographed at twenty-four frames per second. Today, most commercial films are photographed in the 35 mm feature film format (with four perforations per frame). That format does not allow for sufficient visual information storage to deliver the full effect of the previous Weisgerber invention, which requires the 70 mm film format for the full desired effect. Films produced in the 35 mm format can be converted to the 70 mm format for this purpose. Most importantly, twenty-four discrete images each second are not enough to provide for the smooth appearance of motion delivered by the previous Weisgerber invention Additional images must be added and, unfortunately, analog film methods also add undesirable amounts of blurring to the transitional “in between” images that are synthesized through image compositing.

Smoothness of motion, as seen by the audience, is especially important in modern motion picture theaters. Their screens are, in many cases, fifty feet or more in width. Any finely-delineated motion projected onto such a wide screen must traverse a greater distance on that screen between images than is traversed on older screens, which were seldom over forty feet wide. In order for motion to appear smooth, it is necessary to add an extra image between each of the original images of a motion picture film. This way, the large distance displaced by each image element from one image to the next does not impart a jerky appearance to the film as projected. The present invention solves this problem by using technology originally designed for a different purpose, as shall be shown.

As Weisgerber 614 teaches, motion picture feature films photographed and projected at 48 frames per second convey a significantly more realistic presentation of motion than do films photographed and projected at 24 frames per second (conventional frame rate). This difference accounts, in large part, for the novelty of Weisgerber 614 and his subsequent invention, U.S. Pat. No. 5,739,894 (other frame rates). Actual photography at 48 frames per second or a higher frame rate delivers an improved presentation compared to 24 frames per second, but only newly-produced films can be photographed at that rate. For previously-produced films, or for films which could not be feasibly photographed at a high frame rate, the enhancement of images captured at the rate of twenty-four frames per second is required.

It is the primary objective of this invention to produce such image enhancement. The purpose of this enhancement is to allow for the release of motion pictures that contain images that will appeal to contemporary audiences, although the motion pictures themselves depict action that occurred and had been photographed in the past.

With advances in storage and presentation of visual information at higher frame rates, the motion picture images of the past can appear unimpressive to audiences accustomed to contemporary motion picture and television presentation. The “legacy” look of 24 frame-per second presentation appears “nostalgic” and gives the impression of cinema art of another era. The reaction of a contemporary audience to motion pictures photographed at twenty-four frames per second can be analogized to the reaction to a listener to a recording of a previous era. The frequency response (or lack thereof) and signal to noise ratio of the old recording indicate to the listener that the recording is, indeed, old. While a listener may be willing to sacrifice sound quality to hear a vintage performance, it cannot be assumed that a contemporary motion picture audience would be similarly impressed with the appearance of an “old” motion picture (unless the audience specifically attends the showing of a “classic” film, and nostalgia is part of the experience). With video games and other contemporary entertainment produced at the rate of thirty or sixty images per second, contemporary audiences often find the “legacy” look of films produced at twenty-four frames per second to lack sufficient realism to produce the experience they expect.

The present invention presents the appearance of“immersive”, high-impact motion pictures by enhancing previously-produced motion pictures to replicate the image quality typically associated with advanced motion picture technology. By using contemporary computer techniques, motion pictures that actually captured motion at the rate of twenty-four frames per second can be enhanced to appear as though the motion had actually been captured at forty-eight frames per second. This allows release of previously-produced motion pictures, with an image quality that will satisfy contemporary audiences. Thus, the motion pictures treated according to this invention can generate a new revenue stream for their owners.

### BRIEF DESCRIPTION OF THE INVENTION

The invention described here is a method for enhancing existing films, so that they can be shown according to the invention previously taught by Weisgerber. The invention uses the 70 mm film format, with five perforations per frame in the preferred embodiment. Since nearly all films that were ever commercially produced were photographed at twenty-four frames per second, the primary objective of the invention is to enhance films originally photographed at that frame rate, so that they can be projected at forty-eight frames per second with the quality of presentation that only the higher frame rate can deliver.

Mere projection at the higher frame rate cannot be done with analog film technology, except by double-frame printing. Double-frame printing cannot realistically simulate the motion that the camera would have captured if the film in question had actually been photographed at a higher frame rate. However, such realistic motion can be simulated using computerized techniques originally designed to produce additional film frames to create slow-motion effects in motion pictures. The present invention goes far beyond the mere interpolation of extra frames, as will be explained.

In the practice of the invention described here, motion picture films that have already been photographed and produced for public exhibition are first digitized by conventional means known in the art. Then computerized techniques are used to produce new images for interpolation between each successive pair of original images. In this manner, the number of film images is doubled, so the resulting film can be projected at forty-eight frames per second to present forty-eight discrete images every second. These motion pictures can be shown either through conventional projection, or through digital exhibition methods, as known in the art. For conventional projection, they are converted back to an analog “film” form through means known in the art.

In the present invention, computer software is used to produce a transitional “in-between” image for interpolation between each pair of successive images in the original motion picture film. Mere interpolation of an image that appears “half way between” the previous image and the next image (positioned with respect to each image to be interpolated) is not sufficient to deliver the desired effect. Instead, the software used in the invention actually analyzes the apparent motion change through each sequence to generate an image to be interpolated between each image of the original film and the next image of the original film. Because the original images of the film are in digital form when the interpolated images are added, the software enables the user of this invention to control each individual pixel of every image of the entire motion picture film. The software is used to produce interpolated images that would appear consistent with the motion of the objects originally photographed. The result is the depiction of what the film would have looked like if twice as many discrete images were originally captured than actually were.

The computerized techniques used in this invention impart the correct amount of motion displacement to each pixel that comprises each of the images that form the films subjected to this enhancement and conversion method. Through this technique, films that were actually photographed at twenty-four frames per second will appear as if they had originally been photographed at forty-eight frames per second. Films originally produced in the 35 mm format can also be converted to the 70 mm format by adding sufficient visual information to fully exploit the resolution available with the 70 mm film format. In the practice of the invention, information is added to the original motion picture film in four ways. First, grain is removed, thereby reducing “noise.” Next, “in-between” images are created and interpolated using motion vectoring, thereby adding the necessary visual information. Then, motion blur is reduced. Finally, the image is sharpened. The removal of these artifacts dramatically improves the appearance of the motion picture enhanced by this invention. In effect, these artifacts create a veil that reduces the perception of realism that the viewer of the motion picture experiences. The process described in the present invention “removes the veil” to provide an immersive experience comparable to viewing real life.

Moreover, computer-generated images can be added to only certain scenes or sequences in a film, if desired. Under this option, other scenes would not be altered and would be double-frame printed, for projection of the entire motion picture at forty-eight frames per second. In other words, the added realism that stems from the motion vectoring accomplished by the software used in the invention would be imparted to certain scenes or sequences of a motion picture and left out of other scenes or sequences. This allows the filmmaker to control whether or not the artifacts that deliver the “legacy” look (such as motion blur) are actually suppressed in any specific scene of a motion picture. This is a feature of the film experience not available with conventional film methods, and only disclosed previously by Weisgerber for new films produced specifically to deliver this effect. Until the present invention, this effect was not available with any films that had previously been produced.

### BRIEF DESCRIPTION OF THE DRAWINGS

FIG. 1 shows five frames of motion picture film, lettered A through E. A vertical line is shown in each frame to illustrate movement of that line across the frame's field of view.

FIG. 2 shows nine frames; the five frames shown in FIG. 1, plus four other frames interpolated between them. Again, a vertical line is shown in each frame to illustrate movement of that line across the frame's field of view.

It should be noted that the drawings are presented in a highly simplified manner. The images that are enhanced in the actual practice of the invention are far more complex, due to both the inherent complexity of the images themselves and the motion vectoring process used in the enhancement of those images.

### DETAILED DESCRIPTION OF THE INVENTION

For enhancement of existing motion picture films to be shown at a frame rate of forty-eight frames per second of higher, the films are converted from analog to digital form by any means known in the conventional art. In addition, if a motion picture was originally photographed for exhibition in the 35 mm format, it is also necessary to add sufficient picture information to allow for reformatting onto the 70 mm film format without loss of picture quality. The process for this enhancement, as described previously, comprises suppression of grain, interpolation of synthesized images generated by motion vectoring, reduction of motion blur and sharpening of the resultant image.

Once the images are in digital form, a new image is generated for interpolation in a new frame, between each image of the original motion picture and its successive image. These “in between” frames contain new discrete images, generated by computer software. Retimer®, developed by Reelviz, S.A., is suitable for this application. The advantage of Retimer® lies in the manner in which the program generates the additional images for insertion into the image sequence. The program analyzes the movement of each individual pixel of information, through each sequence of images. It should be noted that the promotional literature for Retimer®, as found on the company's web site, www.realviz.com, does not mention the application proposed in the present invention as an application suitable for the Retimer® software.

As an example, consider an object (part of an image) depicted in a motion picture that appears to move from left to right across the screen upon which the motion picture film is projected. In the conventional art of twenty-four frame-per-second presentation, the object would be seen twenty-four times each second, at different places on the screen. Had the movement of the object instead been captured at forty-eight frames per second, there would have been twice as many images of the object, and the object would appear to move approximately half as far from one image to the next than in the twenty-four frame-per-second example.

If the image of the object were to travel across the screen at a constant velocity, the newly-interpolated images would appear exactly half way between each pair of successive images in the original film. However, actual motion in real life entails accelerations and decelerations. The software calculates these accelerations and decelerations and generates new images that accurately depict the actual locations of all objects photographed, as they would have actually appeared if twice as many images had been originally captured than actually were.

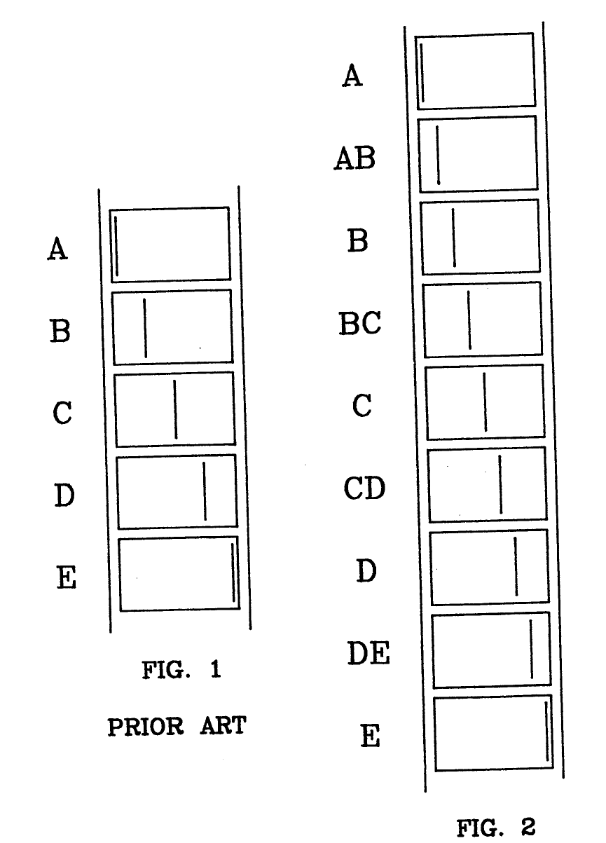

The effect of the interpolation and motion vectoring of these synthesized images can be seen by referring to the drawings. FIG. 1 shows five frames of motion picture film, lettered A through E. These frames represent a short sequence of an existing motion picture film, of up to feature length. Instead of the live action that would typically be photographed, FIG. 1 shows a vertical line moving across the field of view represented by the frames in the drawing. In Frame A, the line is at the left side of the frame. It moves one quarter of the distance to the right at Frame B, one half of the distance to the right at Frame C, three quarters of the distance to the right at Frame D, and is located at the right side of the frame at Frame E. It should be noted that, the wider the screen onto which the film is projected, the greater the amount of distance traveled between the positions of the line from one frame to the next. This disparity of displacement causes objectionable stroboscopic effects when conventional motion picture films are projected at twenty-four frames per second onto large theatrical screens. The larger the screen, the more objectionable the disparity of displacement becomes.

FIG. 2 shows the same film sequence, after enhancement according to this invention. The same five frames from FIG. 1 are shown, but there are now added four new images, one placed between each of the original frames. Images AB, BC, CD and DE are new computer-generated images, designed to appear as if they were discrete images, the way they would look if they were photographed at double the original frame rate of photography (typically forty-eight frames per second, instead of twenty-four). This process is repeated for the entire length of the motion picture film to be converted for exhibition. It should be noted that the position of the vertical line has moved approximately half the distance between images, compared to the smaller number of frames in FIG. 1. This reduced disparity of displacement from one image to the next cuts down significantly on the undesirable stroboscopic effects inherent in projection at conventional frame rates onto large theatrical screens. It should be noted that the illustration in the drawings is greatly simplified. Since the pixels that comprise actual film images move at differing velocities from one image to the next, it is necessary to analyze the actual horizontal and vertical displacements of each pixel from one image to the next and synthesize interpolated images that precisely simulate the motion of the objects depicted. That is the process followed in the present invention.

The depiction of the lines in the newly-formed images is simplified for illustrative purposes. If the line in the illustration had been an actual object in a sequence of motion picture images, its placement on each interpolated image would be determined by the capability of the software to analyze motion, and would represent the actual position that the object would have assumed if it had been photographed at the actual frame rate of projection. The word “approximately” in the previous paragraph is critical. In reality, objects that appear to move across the motion picture screen accelerate and decelerate during the apparent journey. If an object actually moved at a constant velocity throughout its range of motion, then each object in the interpolated image would appear exactly half way between its position in the previous image and its position in the subsequent image. A method that produced interpolated images that appear to place all objects exactly half way between their locations in the previous image and the subsequent image would introduce errors; because it would fail to take into account the accelerations and decelerations of the objects as they were photographed.

For example, consider a ball thrown by a person seen on the left side of an image, to another person seen on the right side of the same image. The ball is thrown toward the recipient and with an upward component, so it rises in altitude, and then falls again, to reach an altitude at which the recipient can catch it. From the time the ball is thrown until it reaches its zenith, it is decelerating. Between any two time points, there is a forward (horizontal) component and an upward (vertical) component to the motion of the ball. Because the ball is moving toward the zenith of its trajectory, the vertical component of its motion decreases, resulting in a deceleration of upward motion. After the ball has reached its zenith, it begins to fall. At that time, the downward (vertical) component of its motion (caused by gravity) increases, as horizontal motion toward the recipient continues.

The software used in the present invention divides the motion of the objects (composed of a multiplicity of pixels) that form an image into intervals one twenty-fourth of a second long, corresponding to each frame of a motion picture. Within each such increment of motion, the software analyzes changing velocities of the objects in each image and determines the position of each such pixel at the midpoint in time between the previous image and the next image in sequence. Accordingly, the result is a highly accurate representation of the actual scene as it would look if it had actually been photographed at double the frame rate at which the images were originally photographed or produced. In other words, if a motion picture originally photographed at twenty-four frames per second is processed according to the invention described here, the result would look the way the same picture would have looked if it were actually photographed at forty-eight frames per second. In this manner, artifacts present at the lower frame rate would be suppressed. Moreover, the motion seen by the viewers of films enhanced according to this invention would see motion as it would actually appear, not a pseudo-motion synthesized by interpolating images exactly half-way between the previous and next image in the original film, whether or not the “half-way” images accurately depicted the motion shown in the picture.

The software used in the practice of the invention can produce images that duplicate the scene as it actually would have appeared at the moment in time exactly halfway between each image and its successor by controlling each pixel individually. The software calculates motion vectors for each individual pixel or group of pixels, and estimates the actual displacement of each such pixel from one frame to the next. Each pixel is moved in the horizontal and vertical directions by the appropriate amount from one image to the synthesized image halfway between the previous image and the next one. The amount that each pixel is moved is determined by the recent history of displacement of that pixel over the run of recent previous images. In other words, the software analyzes the displacement of each pixel from frame to frame, taking into account the velocity of that pixel at any given frame (first time derivative of the displacement) and any changes in velocity that occur in the movement of that pixel (second time derivative of displacement). In that way, the displacement of every pixel is charted for each image of the entire motion picture film. Given these motion vectors for each pixel, the software produces a precise “in between” image for interpolation between each image and its successive image of the original film to replicate what the motion picture would have actually looked like if it had been photographed at double the frame rate at which it was originally photographed or produced. The software also permits manual adjustment of the location of any pixel or group of pixels to modify the image that the software presents as the simulated “in-between” image. Therefore, the user of the invention described can synthesize the entire set of interpolated images, pixel by pixel, to generate a motion picture film that has twice as many images as the same motion picture originally had, with the “improved” picture appearing exactly as it would if it had originally been photographed or produced at the higher frame rate.

The resulting “film” in digital form is then either projected digitally according to methods known in the art, or it is converted back to an analog “film” format for projection at forty-eight frames per second. In the preferred embodiment of the invention, the 70 mm theatrical film format is used, with five perforations per frame, with the image on the film stretched anamorphically to the equivalent of an eight-perforation frame. This creates a taller image and one with a more “square” aspect ratio than the 2.21 to 1 that is normally found in the 70 mm format with five perforations per frame. Therefore, the motion pictures enhanced according to this invention will utilize more screen height than does the conventional 70 mm (five-perforation) film format, which would deliver a “letterbox” look. The films prepared for exhibition according to this invention can be stored on 70 mm film in the five-perforation format, anamorphically compressed. The aspect ratio can be changed by anamorphic expansion upon projection.

In the present invention, projection takes place at forty-eight frames per second, and the use of a double-bladed shutter on the projector delivers the display of ninety-six impressions per second to the viewers of the film. The present invention allows forty-eight discrete images to be delivered to the audience every second during the entire film presentation. As perceived by the viewers of the film, the forty-eight images presented every second appear to fully depict the scene as if it were actually photographed at forty-eight frames per second. Projection must be accomplished at forty-eight frames per second or a higher frame rate (or its digital equivalent) to achieve the desired result. Either analog or digital projection methods can be used in accordance with this invention.

The use of a double-bladed shutter at forty-eight frames per second further improves the quality of the images delivered to the audience, since it allows for a significantly higher light level than is available with 24-fps projection (48 impressions per second with a double-bladed shutter). This results in higher image contrast and improved color rendition. In addition, light levels in excess of sixteen footlamberts are achievable without projection flicker, as compared to the conventional flicker threshold of twelve to sixteen footlamberts. This increased level of screen brightness is available with the use of a double-bladed shutter, because the delivery of ninety-six impressions per second eliminates flicker and other artifacts sufficiently to allow the brighter light level without objectionable artifacts.

The benefits obtainable through the use of a double-bladed shutter at forty-eight frames per second can be achieved through the use of a projector capable of accomplishing pulldown in an interval of five milliseconds or less; twice as fast as can be done by a conventional Geneva-movement projector. This technique was previously disclosed by Weisgerber in U.S. Pat. No. 5,627,614 (1998).

The invention described delivers enhanced versions of films produced in the 35 mm format by augmenting the information packing density associated with the 35 mm format, to the level associated with the 70 mm film format. In effect, the method described here adds more information to existing films, so the audience will perceive more visual information than was placed onto the original film in the original production. While it is envisioned that the invention described will be used primarily with motion pictures produced through film methods known in the art, the invention is also suitable for enhancement of motion pictures produced through 24P digital production acquisition, with its information storage capability of 1080×1920 pixels.

The beneficial effect of this invention can also be imparted selectively to specific scenes or sequences of a motion picture. When the user of the invention desires to have the audience perceive the full impact available, the invention is used to enhance only those specific scenes or sequences. For other scenes or sequences, the original frames would be double-frame printed. This retains the artifacts inherent in double-frame printing, that the present invention is designed to eliminate. Thus, these artifacts can be either eliminated or retained for any specific scene or sequence of a motion picture. As with the previous Weisgerber inventions, the benefit can be imparted and removed selectively when enhancing a previously-produced motion picture.

The present invention also allows previously-produced stock footage (often stored in film libraries and film studio collections) to be enhanced in a cost-effective manner for use in new film production. By using the invention described, such “stock” film sequences (photographed at twenty-four frames per second) can be converted to appear as if they had been photographed at forty-eight frames per second, with the motion vectoring feature simulating the look that would have been captured by actual 48-fps photography. Such “stock” sequences can then be used in connection with the production of new motion picture films, with no loss of image quality due to the use of images that had been recorded in an “old” format and through an “old” method.

By using digital enhancement methods and computerized image creation to add sufficient information to each image to accommodate the 70 mm format, as well as to generate new images to fit between each of the previously-photographed images, conversion can be accomplished efficiently, without loss of light, image clarity or resolution associated with optical conversion methods. The method described reduces grain and improves apparent resolution, resulting in an “immersive” presentation, which delivers the image clarity associated with real life.

The invention described permits the showing of a previously-produced motion picture film with the level of picture clarity consistent with new motion picture production. Contemporary film standards now render the conventional frame rate of twenty-four frames per second inadequate to sufficiently suppress undesirable artifacts such as stroboscopic effects. With the actual analysis of motion vectors between each frame, however, the interpolated images developed in accordance with this invention eliminate stroboscopic effects by duplicating the motion that the camera would have actually captured if it had operated at the higher frame rate in the first place.

In addition, the amount of magnification now used in the motion picture art requires the level of image quality consistent with the practice of this invention. Magnifying an image on 35 mm film to a screen larger than forty-five feet wide only displays the shortcomings of the 35 mm film format. Use of the 70 mm format delivers a high-quality presentation on screens up to eighty feet wide. On screens that large, however, interpolation of motion cannot be acceptably smooth for any fast motion projected at twenty-four frames per second. The displacement between frames is simply too large. With the present invention, the actual displacement of an object on the screen is calculated, and objects are shown as being in the correct location on every synthesized “in-between” image. This result is not available through other means.

Another collateral benefit of this invention is that the dynamic image enhancement described also reduces grain, sharpens images and produces an image with a superior appearance on large theatrical screens, compared to those available through conventional means. With conventional film technology, there is more objectionable grain and lower apparent resolution than with the present invention.

Digitizing the film images before engaging in the enhancement process improves the impact of a theatrical motion picture presentation without sacrificing picture quality. This reduction of picture quality is inherent in optical enlargement of films originally produced in the 35 mm film format and converted to the 70 mm film format. In effect, the change in formats is done much more efficiently with digitized images than with conventional film images. In addition, the impartation of “transitional” images that effectively produce the actual appearance of an image that would have been photographed between each pair of images in the original motion picture is only available through use of the invention described here.

While the basic invention and the preferred embodiment have been described, this description should be thought of as illustrative and not limiting. Other frame rates, such as fifty or sixty frames per second, can be used. So can other film formats. Other embodiments are also possible, and they should be thought of as lying within the scope of the invention.

The invention claimed is:

1. A method for converting previously-produced motion picture films for projection at a higher frame rate than that in which such films were originally produced, to motion picture theater audiences, with the effect of improving the presentation of such films to the members of such audiences, the method comprising: the conversion of each of the images in said motion picture to a digital format; the formulation of images which accurately depict the scene of the motion picture at a time interval half way between the appearance of one such image and the next successive image in said motion picture film; the interpolation of these transitional images between each original image of said motion picture film and its successive image; the conversion of said motion picture to an analog or digital form suitable for projection; and the projection of such film at double the frame rate at which said film was originally produced.

2. The method as in claim 1, in which said transitional images are generated using computerized imaging techniques.

3. The method as in claim 2, in which said transitional images are generating using software that analyzes the apparent motion of each pixel of each image actually photographed during the preparation of such motion picture film, and generates new images to depict the actual motion of each of said pixels, with the result that each of said synthesized images would appear identical to the look that each such image would have had if said motion picture film had actually been photographed at the same speed at which it is projected.

4. The method as in claim 1, in which films originally produced for projection at twenty-four frames per second are converted according to the method described for projection at forty-eight frames per second.

5. The method as in claim 1, in which projection is accomplished through a double-bladed shutter.

6. The method as in claim 1, in which certain scenes or sequences comprising a single motion picture are enhanced according to the method as in claim 1, while other scenes or sequences that comprise the same motion picture are not enhanced.

7. The method as in claim 1, in which films enhanced according to the method described are exhibited to audiences in the 70 mm film format.

8. The method as in claim 1, in which in which previously-photographed motion picture film sequences are enhanced according to the method as in claim 1, for insertion into motion picture films as a component of such films.

9. A method for converting previously-produced motion picture films for exhibition to audiences at double the frame rate at which said films were originally photographed, for delivery of heightened impact upon the members of said audiences, where the improvement comprises the use of computerized image-generating techniques to produce transitional images; such techniques evaluating the motion of each pixel of each of the images in the original film, and such transitional images being inserted between each of the original images of said film to accurately depict the exact appearance that said previously-produced motion picture would have had if it had originally been photographed at the frame rate at which it is projected to said audiences.
